(19) United States
(12) Patent Application Publication
(10) Pub. No.: US 2011/0214625 A1
(43) Pub. Date: Sep. 8, 2011

(54) Heat engine

(76) Inventor: Jörg Nickl, Malter (DE)

(21) Appl. No.: 13/040,867

(22) Filed: Mar. 4, 2011

(30) Foreign Application Priority Data
Mar. 4, 2010 (DE) DE102010010 298.9

(51) Int. Cl. F02B 73/00; F01K 23/06

(52) U.S. Cl. 123/2; 60/670

(57) ABSTRACT

The invention relates to a heat engine having a working medium cycle, comprising: an evaporator for evaporating the liquid working medium; an expander for expanding the evaporated working medium; a condenser for liquefying the expanded working medium from the expander; and a working medium pump for supplying liquid working medium to the evaporator, wherein a valve is provided for controlling the amount of working medium conveyed from the working medium pump to the evaporator. The invention is characterised in that the valve comprises: a valve seat; a valve body; a sensor connected via a gas pressure line or other pressure-conducting connection; and a control member on the valve body or additionally to the valve body, wherein the valve body regulates the flow rate of the working medium through the valve according to its position relative to the valve seat and the control member influences the position of the valve body according to a control pressure conveyed via the sensor and dependent on a state variable of the working medium or another medium.

### BACKGROUND OF THE INVENTION

1. Field of the Invention

The invention relates to a heat engine having a working medium cycle. In addition, the invention relates to a drive device.

2. Description of the Related Art

Heat engines which work according to the Clausius Rankine cycle are known from the general prior art. In its simplest form, a heat engine for this thermodynamic cycle substantially comprises four main assemblies: an evaporator unit for evaporating the liquid working medium, an expander for expanding the evaporated working medium, a condenser assembly for liquefying the expanded working medium, which for example can also comprise a reservoir for the liquid working medium, and a working medium pump which removes the working medium from the reservoir and supplies it to the evaporator. These assemblies are connected to one another via corresponding lines.

Nowadays, such heat engines should also be used in commercial vehicles fitted with an internal combustion engine. The waste heat produced in an internal combustion engine, for example, from the exhaust gas of the internal combustion engine, can be used to drive the downstream heat engine and thus the overall efficiency of a drive device comprising an internal combustion engine and a downstream heat engine can be increased. A problem area in heat engines is the control or regulation of the working medium pump. Either a working medium pump having an adjustable conveying capacity must be provided or an unregulated working medium pump with a working medium pump bypass is provided, wherein the amount of working medium fed to the evaporator is influenced by opening a valve in the bypass to a greater or lesser degree. With increasing closure of the valve in the bypass, more working medium is fed in the direction of the evaporator and with increasing opening of the valve in the bypass, less working medium is fed to the evaporator.

Nowadays, electronic control devices are usually provided for such control or regulating tasks, which either vary the suction volume of the working medium pump, in particular with an electrical drive or change the opening position of the valve in the bypass line. However, every control device additionally provided in a drive train is on the one hand associated with costs and electronic interconnection expenditure and on the other hand requires a redundant backup when controlling safety-related units. In addition, experience shows that electronic control devices are susceptible to faults.

It is accordingly the object of the present invention to provide a heat engine with a control for a working medium pump which is simple and robust and always works reliably. A drive device with such a heat engine should furthermore be provided.

### SUMMARY OF THE INVENTION

The object according to the present invention is achieved by a heat engine having a working medium cycle, comprising an evaporator for evaporating the liquid working medium, an expander for expanding the evaporator working medium, a condenser for liquefying the expanded working medium from the expander, and a working medium pump for supplying liquid working medium to the evaporator, wherein a valve is provided for controlling the amount of working medium conveyed from the working medium pump to the evaporator, characterised in that the valve comprises a valve seat, a valve body, a sensor connected via a gas pressure line or other pressure-conducting connection and a control member on the valve body or additionally to the valve body, wherein the valve body regulates the flow rate of the working medium through the valve according to its position relative to the valve seat and the control member influences the position of the valve body according to a control pressure conveyed via the sensor and dependent on a state variable of the working medium or another medium. Further, the object according to the present invention is achieved by a drive device comprising an internal combustion engine and a heat engine according to the immediately preceding sentence, which is configured in such a manner that waste heat from the exhaust of the internal combustion engine can be supplied to the closed working medium cycle of the heat engine for driving the steam engine, wherein the sensor of the heat engine in particular is in heat-transferring communication with the main steam of the evaporator and/or the exhaust gas of the internal combustion engine, in particular in the region of the inlet of the exhaust gas into the evaporator.

The heat engine comprises according to the present invention a valve for controlling the amount of working medium conveyed from the working medium pump to the evaporator. The valve has a valve seat which is formed in particular by a valve housing and a valve body. The valve body is usually located inside the valve housing and can, for example, be configured as valve tappet. However, other arrangements of valve body and valve housing are also feasible.

The valve body regulates the flow rate of the working medium through the valve according to its position relative to the valve seat or the valve housing. In this case, a control member influences the position of the valve body according to a control pressure conveyed via a sensor. The control pressure depends on a state variable. A gas pressure line or another pressure-conducting connection between the sensor and the control member can be provided for transmitting the control pressure from the sensor to the control member which can be executed on the valve body, for example, in the form of a pressurised surface or which can be provided in addition to the valve body. This connection can be implemented, for example, as a capillary.

In this way, a control or regulation of the heat engine operating independently of a control unit or control electronics can be accomplished. With a suitable choice of the sensor position and therefore in particular the selection of a suitable state variable of the working medium, an increase of the flow from the working medium pump to the evaporator can be accomplished, for example, with a suitable increase in the value of the state variable, and conversely. The state variable of the working medium comprises a temperature. The working medium cycle can in particular be closed but an application of the valve according to the invention in an open working medium cycle is also possible.

A particularly preferred embodiment of the invention provides that the control member comprises a membrane or a piston. In an embodiment of the control member as a membrane, for example, the deflection or deformation of the membrane as a function of a working medium pressure prevailing in the valve housing and a control pressure imparted by the sensor and the capillary, can act on the valve body and thus control or regulate the flow of the working medium. Such a control or regulation can take place similarly in an embodiment of the control member as a piston.

In particular in one of the preceding embodiments, it can be provided that the sensor comprises a gas volume around which a main steam or an exhaust gas flows. The main steam can comprise the working medium emerging from the evaporator. The exhaust gas can comprise that entering into the evaporator and originating from the internal combustion engine which is coupled with the heat engine.

In an advantageous embodiment it is provided that the valve is disposed parallel to the working medium pump, in particular between the suction side and the pressure side of the working medium pump. The formation and/or arrangement of the valve parallel to the working medium pump as a bypass valve allows a particularly simple and therefore cost-effective configuration of the heat engine.

A particularly preferred further development of the invention provides that a first and a second control member are provided for controlling the flow rate through the valve. This makes it possible to take into account a further state variable of the working medium. A significantly more complex control of the heat engine based on one or two valves can therefore possibly comprise the regulation of the entire vapour cycle.

Allowance for a second state variable when controlling the flow rate allows a more accurate control of the heat engine and therefore in particular of the thermodynamic cycle. In this case, the second control member can be designed to be identically acting to the first control member or to be compensating or counteracting to the first control member.

In particular, it can be provided that the first control member is designed for controlling the flow rate according to a first state variable ratio of the working medium and the second control member is designed for controlling the flow rate according to a second state variable ratio of the working medium. Allowance for two state variable ratios enables complex and comprehensive control of the thermodynamic cycle of the heat engine by means of simple mechanical means, which render electronic control of the cycle superfluous.

A particularly preferred embodiment of the invention provides that the first and/or the second control member comprises/comprise a gas side and a working medium side, wherein a gas pressure dependent on a temperature of the evaporated working medium is applied on the gas side of the first control member. Additionally or alternatively to this, the gas pressure applied on the gas side of the first control member can also be dependent on an exhaust temperature of an internal combustion engine. Furthermore, it can alternatively or additionally be provided that a pressure of the working medium in the liquid state of aggregation is applied on the working medium side of the first control member. In addition, the working medium side and/or the gas side of the control member can be acted upon by a spring force. In particular, the pressure of the liquid working medium can comprise the working medium pressure prevailing on the evaporator-side outlet (of the pressure side) of the working medium pump or the working medium pressure prevailing on the condenser-side inlet (of the suction side) of the working medium pump. The exhaust temperature which is represented by the gas pressure prevailing on the gas side, can comprise the temperature of an exhaust gas of an internal combustion engine at the evaporator inlet. The vapour temperature of the evaporated working medium can comprise the main steam temperature at the outlet of the evaporator of the heat engine.

The control member thus pressurised can control the flow rate through the valve in cooperation with the valve body such as possibly a valve cone cooperating with a valve seat and thereby, in the event of a suitable arrangement parallel to the working medium pump, adjust the amount of working medium effectively conveyed from the working medium pump to the evaporator. If the evaporator pressure increases, for example, that is the pressure of the liquid working medium on the evaporator side of the working medium pump without the main steam temperature of the evaporated working medium increasing, the valve opens and the working medium pump conveys correspondingly less working medium. As a result, the vapour pressure in the evaporator decreases. If an evaporator pressure corresponding to the vapour temperature of the working medium, that is the sensor temperature, is too low, the valve is closed more so that the flow from the working medium pump to the evaporator and therefore in turn the evaporator pressure increase. The overheating or in general the relationship between pressure and temperature is consequently regulated automatically even in the event of a supercritical operating mode at the working-medium side evaporator outlet of a heat engine. The sensor can thereby be disposed at the beginning of the main steam line, for example, in the interior of the evaporator and be mounted in the form of a gas container in a good heat-conducting manner. In particular, it can be provided that the sensor has an incoming hot gas, for example, exhaust of an internal combustion engine, flowing around it. It is thus ensured that at the beginning when no vapour is yet produced in the evaporator, the valve closes and the working medium is conveyed from the working medium pump to the evaporator. For stability reasons the capillary can be guided to the valve under the insulation of a main steam line of the evaporator.

According to a further embodiment of the invention, it can be provided that a gas pressure dependent on the temperature of the liquid working medium on the condenser-side inlet (suction side) of the working medium pump is applied on a gas side of the first or the second control member and a spring force and/or the pressure of the liquid working medium on the condenser-side inlet of the working medium pump is/are applied on a working medium side of the first or the second control member. This configuration of the control member can be provided additionally or alternatively to the previously described control member in the valve. According to the invention, therefore, in a first embodiment the first and the second control member can be disposed in one valve whereas an alternative embodiment provides two separate valves. In the first embodiment, it can be provided that the first and the second control member act on a common adjusting element.

The contact of the control member with the suction-side fluid of the working medium pump on the working medium side, for example, the condensate of the heat engine and the contact of the gas side of the control member with a closed gas-filled volume which depends on the extraction temperature of the working medium pump thus, for example, according to a first embodiment, allows a second possibility for controlling the flow rate through the valve. While the gas-side gas pressure depends on the suction temperature of the working medium pump, the condenser pressure always prevails on the working medium side of the membrane. This can be equal to the ambient pressure in a particular embodiment of the present invention. Consequently, if the suction temperature of the working medium pump increases, the gas-side gas pressure also increases, with the result that when the compressive force of the liquid working medium is exceeded, optionally assisted by a spring force, the valve opens further. As a result, the mass flow conveyed through the working medium pump decreases and the overheating at the evaporator outlet and the undercooling at the condenser outlet increase. If the membrane of this embodiment is combined with the previously described membrane, an entire thermal power process can be monitored by means of a simple pump regulating valve.

Alternatively to the previously explained first embodiment, the first control member can be disposed in a first valve and the second control member can be disposed in a second valve. The division of the two control members into two different valves allows a more accurate and more sensitive control or regulation of the heat engine.

Advantageously the heat engine can comprise an additional heat exchanger (also called pre-heater), wherein the heat exchanger is connected to the inlet of the evaporator and to the outlet of the evaporator. With a suitable controller, the liquid working medium supplied to the evaporator can therefore be preheated by means of the vaporous working medium removed from the evaporator. The increase of the working medium inlet temperature at the evaporator brings about a reduced uptake of thermal energy via the evaporator into the working medium cycle.

The thermal energy delivered by the evaporator to the working medium cycle can be controlled, for example, by providing the second valve downstream of the additional heat exchanger as a bypass to the expander. The second valve is influenced by the ratio of working medium pressure and working medium temperature at the condenser outlet.

Consequently, for example, in the event of an increase of the working medium temperature above a critical value on the condenser outlet side with substantially the same working medium pressure, an opening of the second valve takes place. This results in an increased flow of the pre-heater which in turn brings about an increase in the working medium inlet temperature at the evaporator and therefore leads to a lowering of the thermal power and consequently to a reduction of the working medium temperature on the condenser outlet side.

A further embodiment of the invention provides that in addition to the first evaporator, a second evaporator, in particular an exhaust gas recirculation evaporator, is provided. The exhaust gas recirculation evaporator, also known as EGR evaporator, is part of an exhaust gas recirculation system for optimising exhaust gas emissions of internal combustion engines and absorbs heat from the recirculated exhaust gas for evaporation of the working medium of the heat engine. At the same time, it is of particular interest to achieve a specific (lower) exhaust gas temperature of the recirculated exhaust gas as a function of the current operating state of the internal combustion engine. In order to achieve a regulated temperature influencing of the exhaust gas or a defined removal of energy by the EGR evaporator, a distributing valve, for example, can be integrated in the common flow line of the evaporator. The distribution ratio can then be controlled or regulated by reference to the outlet temperature of the exhaust gases.

A likewise advantageous embodiment of the invention provides that the valve has respectively one filling valve for filling the gas side of the first and/or the second control member. This or these filling valves ensure access to the volume of the gas side of the control member and can be filled according to the design up to specific pressures in the cold state. To this end, for example, nitrogen from a compressed gas bottle can be used.

According to a particularly preferred embodiment, it is provided that the condenser of the heat engine is a condenser which is pressure-equalised with the surroundings. At the same time, it can be provided in particular that the assembly comprising the condenser lies above the working medium pump and thus a natural intake height in addition to the undercooling of the working medium fluid, i.e. the evaporation medium, is present at the working medium pump inlet. The entire heat engine is indeed closed from the point of view of the working medium but the working medium condenses at ambient pressure and any over- or underpressure is avoided by a particular tank closure in the condenser assembly. The pressure level of the condenser is consequently adhered to. The pressures in the cycle consequently cannot increase excessively in the event of any inadequate removal of heat at the condenser. The working medium pump would then possibly extract a vapour-liquid mixture. The tank closure is located above the highest point of the condenser and in addition to the possibility for topping up the working medium, also serves to remove lighter non-condensable gases such as possibly infiltrated air.

A preferred further development of the invention provides that a closable connection is provided between the evaporator side of the working medium pump and the condenser. This makes it possible to empty the evaporator in the direction opposite to the usual direction of flow directly into the condenser, whereby the evaporator pressure drops abruptly. This connection can be closed, for example, by means of a magnetic valve. A safety valve which opens if the evaporator pressure is too high, can also be provided in an integrated manner or parallel to this valve.

An advantageous further development of this embodiment of the invention provides that the expander has a siphon at the outlet. As a result, with a significantly higher condenser inlet (primarily in the case of air-cooled condensers), it is achieved that condensate formed in the evaporation line is entrained in the condenser.

It can furthermore be preferred that the working medium comprises ethanol and/or glycerol. Ethanol can act as a thermodynamically optimal evaporation medium whereas glycerol acts as lubricant oil. Both partners are environmentally neutral and mix well in the liquid phase. The glycerol accumulates predominantly in the oil sump of the steam engine, where the greatest density difference between overheated ethanol and liquid glycerol brings about a desired enrichment of the latter.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a schematic drawing of a first embodiment of a heat engine according to the invention;

FIG. 2 shows a schematic cross-sectional view of a steam engine for use in the heat engine according to FIGS. 1 and 4;

FIG. 3 shows a schematic view of an embodiment of a pump regulating valve of the heat engine according to the invention from FIG. 1;

FIG. 4 shows a block diagram of a second embodiment of a heat engine according to the invention;

FIG. 5 shows a schematic diagram of an embodiment of a general regulating valve of the heat engine according to the invention from FIG. 4.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

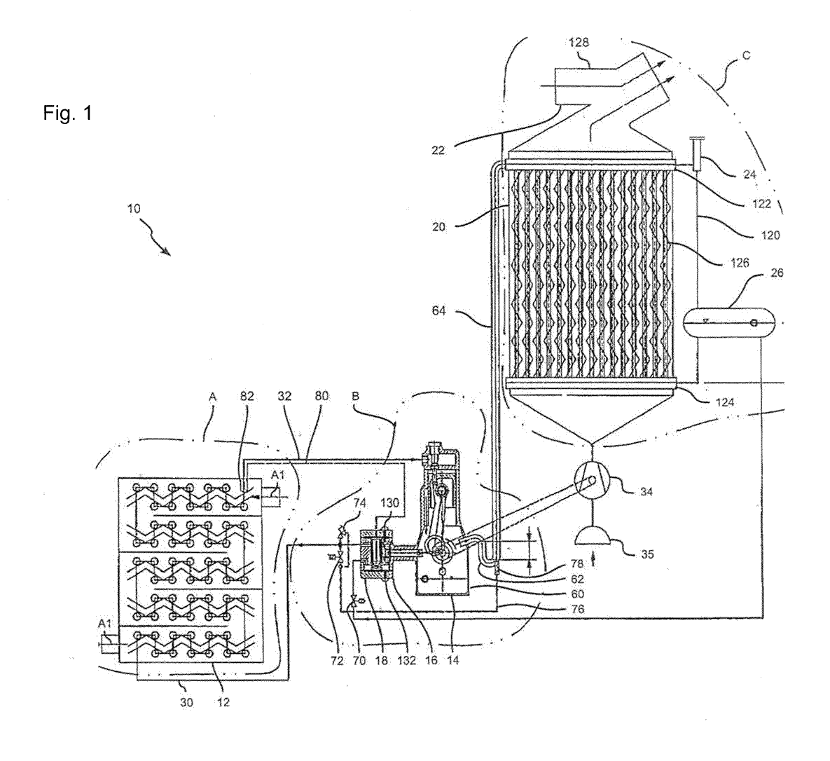

The heat engine shown in FIGS. 1 to 4 in different embodiments is in particular suited, together with an internal combustion engine, to achieve a partial usage of the energy contained in the exhaust gas stream of the internal combustion engine in the form of mechanical energy. The internal combustion engine itself producing the exhaust gas stream is not shown in FIGS. 1 to 4.

The heat engine 10 shown in FIG. 1 operates according to the Clausius-Rankine process and can be divided into four large assemblies: an evaporator assembly A which substantially comprises the evaporator 12 which is integrated in the exhaust gas silencer and isolated as well as corresponding inlet and outlet lines for the exhaust gas of the internal combustion engine and the working medium; an expander pump B comprising an expander 14, also called steam engine, a working medium pump 16 also to be perceived as an assembly and connected to the steam engine, herein in the form of a reciprocating pump, as well as a valve 18 connected to this working medium pump 16 for controlling or regulating the working medium pump 16 and corresponding supply lines or discharge lines and corresponding valves; and a condenser assembly C comprising the condenser 20, an airstream ejector 22, a tank closure 24 and a storage container or reservoir 26.

The fundamental height assignment of the individual assemblies is also deduced from the diagram in FIG. 1. The condenser assembly A is located above the working medium pump 16 of the expander assembly B in order to thus provide a natural inlet height in addition to the undercooling of the working medium at the pump inlet.

The evaporator 12 is designed as a heat exchanger with isolation. The direction of flow of the working medium in the evaporator 12 in FIG. 1 is from bottom to top to prevent water hammer at the expander 14. Accordingly, a favourable exhaust gas flow from top to bottom is obtained at the evaporator, as is indicated by the arrows A1, A2 in FIG. 1. Condensate possibly formed on the exhaust gas side can therefore drain to the bottom. In contrast to the condenser 20, which can be thermodynamically sluggish as a result of its small temperature fluctuations, at the evaporator 12 an unnecessary inertia or capacity must be avoided for the purpose of faster re-adjustment in cases of varying load. This primarily includes a lower fluid content in operation. Here the evaporator 12 is integrated in an exhaust gas silencer so that in the ideal case, no additional pressure losses result for the internal combustion engine.

The evaporator assembly A comprises a working medium supply line 30 by which means the liquefied working medium supplied from the working medium pump 16 is fed to the evaporator 12 and an isolated main steam line 32 which supplies the evaporated working medium to the expander 14.

The expander assembly B with the evaporator assembly A is supplied with the evaporated working medium via the main steam line 32. The main steam line 32 opens into the expander 14.

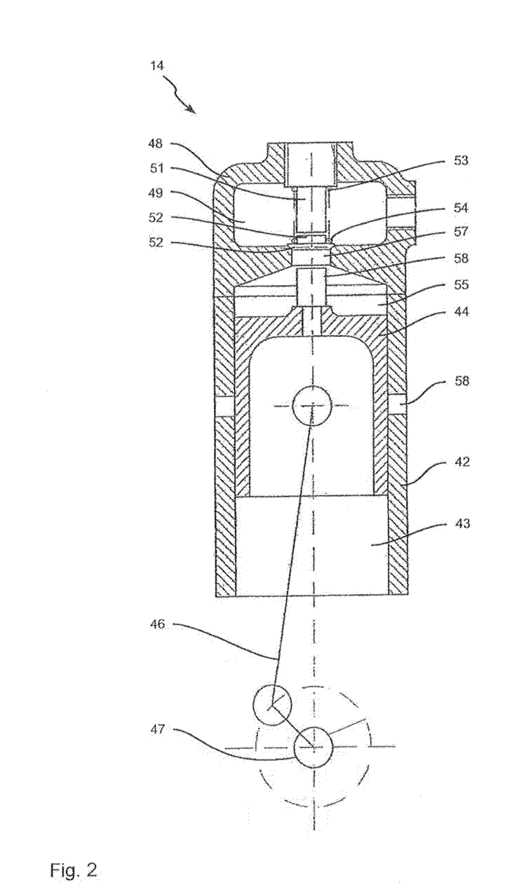

FIG. 2 shows a possible embodiment of the expander 14. The expander 14 comprises a housing 42 and a cylinder space 43 enclosed by the housing 42. A working piston 44 which is designed as a plunger is disposed in the cylinder space 43. The working piston 44 is connected in an articulated manner via a piston pin to a connecting rod 46, depicted schematically here, which for its part is again connected in an articulated manner to a crankshaft 47. The main steam line opens in the area of the cylinder head 48 which forms a part of the housing 42. The cylinder head 48 has an inlet chamber 49 into which the main steam can flow. Furthermore, an inlet valve 51 substantially consisting of a valve body 52 is provided in the area of the inlet chamber 49. The valve body 52 is pressed by the force of a spring device 53 and assisted by the pressure of the main steam in the area of the inlet chamber 49 in the present case with its sealing slope 52a against a valve seat 54 and thereby closes the inlet chamber 49 with respect to a working chamber 55. The working chamber 55 is enclosed by the working piston 44 in the cylinder space 43.

When the articulated connection between the connecting rod 46 and the crankshaft 47 points in the direction of the cylinder space 43, the upper dead point is reached. Shortly before this upper dead point of the working piston 44 is reached, the working piston, through mechanical contact with the valve body 52, pushes said valve body along via a tappet 56 disposed in the area of its piston surface facing the cylinder head 48 into the working chamber 55, against the force of the spring device 53 and the pressure of the main steam in the area of the inlet chamber 49 so that this valve body 52 is raised from its valve seat 54. As a result, the energy-rich main steam present with corresponding pressure and corresponding temperature can flow through the opening 57 exposed by the valve body 52 on the tappet 56 along into the working chamber 55 and thereby push the working piston 44 in the direction of the crankshaft 47. Via the connecting rod 46 and the piston pin, mechanical energy is transferred from the working piston 44 to the crankshaft 47. On leaving the region of the upper dead point, the tappet 56 will at the same time break mechanical contact with the valve body 52 so that this is pressed back into the valve seat 54 by the force of the spring device 53 and seals the region of the inlet chamber 49 with respect to the region of the working chamber 55. As a result of the movement of the working piston 44 in the direction of the crankshaft 47, the main steam is accordingly expanded while simultaneously delivering work to the working piston 44. Shortly before reaching the lower dead point of the working piston 44, i.e. when the articulated connection of the connecting rod 46 to the crankshaft 47 arrives on the side facing away from the working piston 44, the working piston 44 is driven so deeply into the cylinder space 43 that it exposes openings 58 disposed in the lateral surface of the cylinder space 43 in the housing 42. A large proportion of the expanded waste vapour flows from the working chamber 55 through these openings which serve as an outlet for the expanded waste vapour. The working piston 44 is then kept running by the continuing movement of the crankshaft 47 as a result of the inertia and/or further cylinders and is again moved upwards, where the residual vapour is condensed. Shortly before the upper dead point is again reached, the tappet 56 then opens the valve device 51 again through the mechanical contact with the valve body 52 and the sequence described above begins anew.

The openings 58 in the region of the housing 42 lead the waste vapour into the crank housing 60 (see FIG. 1) in which the crankshaft 47 and parts of the connecting rod 46 are disposed. The crank housing 60 can thus be used as a pulsation damper for the waste vapour and as an oil centrifuge. A siphon 62 is arranged in the crank housing 60 at the outlet of the expander 14. When the heat engine 10 is at a standstill, the siphon 62 collects the condensate flowing back from the voluminous waste vapour line 64. When a vapour stream is reinstated, this condensate is entrained into the condenser 20.

In addition to its main purpose, i.e. acting upon a crankshaft of an internal combustion engine for the partial utilisation of the energy contained in the exhaust gas stream of the internal combustion engine, the crankshaft 47 also drives the working medium pump 16 and the fan 34 of the condenser assembly C. The working medium pump 16 is designed as a reciprocating pump with automatic pressure-controlled valves so that there are no shut-off fluid lines even when the magnetic valve 70 on the suction side of the pump 16 is closed when the internal combustion engine is at a standstill to avoid excessive filling of the evaporator. This prevents the working medium from flowing from the storage container 26 through the automatic valves into the lower-lying evaporator 12 or along the pump piston into the crank space of the expander. For a suddenly desired shedding of load, possibly in the event of rapid braking, the evaporator 12 can be emptied directly into the condenser 20 in the direction opposite to the usual direction of flow by means of an additional magnetic valve 72 on the pressure side of the pump 16. As a result, the evaporator pressure drops abruptly. A safety valve 74 which opens when the evaporator pressure is too high, is also provided in an integrated manner or parallel to this valve. In order to avoid an additional long free line between the expander assembly B and the condenser assembly C, the connected bypass line 76 is incorporated as an ejector 78 at the rising end of the siphon 62, which is intended to prevent any back flow of fluid into the expander 14 and excessive oil dilution.

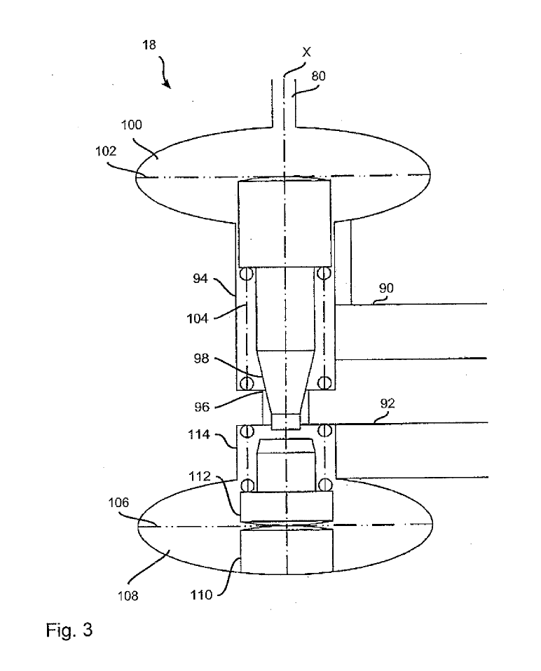

The valve 18 coupled to the working medium pump 16 is connected as a thermostatic bypass valve between the suction and the pressure side of the pump 16. The valve 18 is described in more detail in FIG. 3. Before a detailed discussion of the valve 18, the sensor (temperature sensor) 82 of the valve 18 for regulating the working medium conveyed to the evaporator 12 is explained with reference to FIG. 1. The valve 18 could therefore also be designated as a pump regulating valve. The sensor 82 for the valve 18, connected by means of a capillary 80, in the form of a gas container is attached in a good heat-conducting manner at the beginning of the main steam line 32 in the interior of the evaporator 12 and is placed so that inflowing hot exhaust gas flows around it in the direction A1. It is thus ensured that in the start-up phase of the heat engine in which no vapour is produced, the valve 18 switches to conveyance. This is explained in detail with reference to FIG. 3. For reasons of stability, the capillary 80 is guided under the insulation of the main steam line 32 to the expander 14 on which the working medium pump 16 and its valve 18 are also located.

FIG. 3 shows the pump regulating valve designed as a thermostatic bypass valve, in the present case designated as valve 18. The diagram in FIG. 3 is merely schematic and is intended to explain the functioning of the valve 18. The valve 18 has an inlet 90 which is connected to the pressure side of the working medium pump 16 and an outlet 92 which is connected to the suction side of the working medium pump 16. Inlet 90 and outlet 92 of the valve 18 are coupled to the valve housing 94 shown schematically. A valve seat 96 which cooperates with a valve tappet 98 is provided in the valve housing 94. The valve tappet 98 is configured to be conical in the region of the valve seat 96 and can also have a substantially cylindrical form. In the inflow region of the valve 18 there is provided a first gas volume 100 connected to the capillary 80 which is separated from the remaining interior of the valve 18 by means of a first membrane 102. The valve tappet 98 is located in abutment with the first membrane 102. The valve tappet 98 is acted upon by a spring force via a first spring element 104 in such a manner that it is pressed against the first membrane 102.

The gas pressure dependent on the main steam temperature and slightly dependent on the exhaust gas temperature at the sensor 82 (FIG. 1) reaches the upper side of the first membrane 102 via the capillary 80. The other side of the first membrane 102 is in contact with the evaporator pressure of the liquid working medium which is brought about via a surface acted upon by working medium, in the present case on the underside of the first membrane 102. The spring force of the first spring element 104 is additionally added to this force exerted on the first membrane 102. If the evaporator pressure increases, that is the pressure characteristic of the liquid working medium on the evaporator side of the working medium pump 16, with the temperature of the sensor 82 remaining the same, the valve tappet 98 is urged more strongly in the direction of the first membrane 102 and the flow rate of the working medium through the valve 18 is increased as a result of the cooperation of the conical shape of the valve tappet 98 and the valve seat 96. As a result, the amount of working medium conveyed by the working medium pump 16 into the evaporator 12 decreases, with the result that the vapour pressure of the evaporator 12 drops again (see FIG. 1). If the evaporator pressure corresponding to the temperature of the sensor 82 is too low, the flow rate of the working medium through the valve 18 is reduced so that the amount of working medium conveyed by the working medium pump 16 to the evaporator 12 increases and therefore also the evaporator pressure. Consequently, the overheating or in general the relationship between pressure and temperature is regulated automatically in the event of a supercritical operating mode at the evaporator outlet on the working medium side.

A second membrane 106 is disposed on the outlet side of the valve 18, which separates a closed volume 108 from the remainder of the volume 18. Inside the closed gas volume 108 there is provided a stop element 110 against which a tappet driver 112 which can move along the axis of movement X of the pump tappet 98 is pre-tensioned by means of a second spring element 114. The upper side of the second membrane 106 is in contact with the condenser pressure, that is the pressure of the liquid working medium on the suction side of the working medium pump 16. In the present embodiment, this condenser pressure is equal to the ambient pressure. In addition to this pressure, the spring force of the second spring element 114 acts on the second membrane 106 in the same direction. The gas pressure inside the closed volume 108 depends on the suction temperature of the working medium pump 16, i.e. the temperature of the working medium on the suction side of the working medium pump 16 and acts in the opposite direction. If the suction temperature increases, the gas pressure acting in the volume 108 also increases. If the spring force of the first spring element 114 is exceeded, an additional force is consequently exerted on the pump tappet 98 by impact of the tappet driver 112 and the flow rate of the working medium of the valve 18 is increased. As a result, the mass flow conveyed from the working medium pump 16 to the evaporator 12 diminishes overall and the overheating at the evaporator outlet and the undercooling at the condenser outlet increase.

Consequently, the entire process of the heat engine 10 is monitored by a simple valve 18. Filling valves 130, 132 are provided on the gas-side membrane housings (see FIG. 1) which are filled with specific pressures in the cold state. This can, for example, comprise nitrogen from a compressed gas bottle.

The functionality of the condenser assembly C is now explained with reference again to FIG. 1. As already mentioned, the condenser assembly C is located above the working medium pump 16. In addition to the condenser 20, the condenser assembly comprises a tank closure 24. This is located at the highest point of the condenser 20 and in addition to the possibility for topping up the working medium, also serves to remove lighter non-condensable gases such as possibly infiltrated air. Said closure is also connected via a pressure compensating line 120 to the storage container 26 which is disposed adjacent to the condenser 20 at a specific height. The storage container 26 has a significantly greater fluid volume than the liquid-contacted part of the condenser 20. As a result, the storage container 26 achieves a specific liquid level for undercooling in the condenser 20 and always stores undercooled liquid, even if a small amount of vapour condenses directly on the liquid level. Since a liquid film on the undercooled tube inner wall is harmful during condensing, the condenser 20 is designed with a chimney-like relatively high structure.

Located between two collector or distributor pipes 122, 124 having a relatively large diameter are thinner perpendicular pipes 126 having meandering cooling fins since this external heat transfer is considerably lower than the internal heat transfer.

The condenser 20 in a case of application together with an internal combustion engine located in a commercial vehicle is more favourably placed behind the driver's cab and configured as a heat exchanger. The heated cooling air then emerges via the roof surface. In particular, it is possible to provide an ejector 128 at the end of the cooling air line which brings a certain pressure relief for the fan 34 by means of the airstream. This fan 34 is located together with an air filter 35 at the lower cooling air inlet since the maximum air mass flow can thus be conveyed. At lower temperatures it can be throttled on the suction side in order to achieve a certain power reduction of the directly driven fan 34. This regulation is a compromise and is in any case due to the low power input of the fan 34 according to the design. If there is space available, the condenser 20 could be configured similarly to the water cooler in the frontal region of the vehicle, in principle also as cross-flow heat exchanger.

In the preceding embodiment a mixture of ethanol and glycerol is provided as working medium. Ethanol acts as a thermodynamically optimal evaporation medium while glycerol acts as a lubricating oil. Both partners are environmentally neutral and mix well in the liquid phase which is why glycerol is repeatedly returned to the expander 14 and can only accumulate in the oil sump of the expander 14 where the largest density difference exists between overheated ethanol and liquid glycerol and a desired accumulation of the latter is thus achieved.

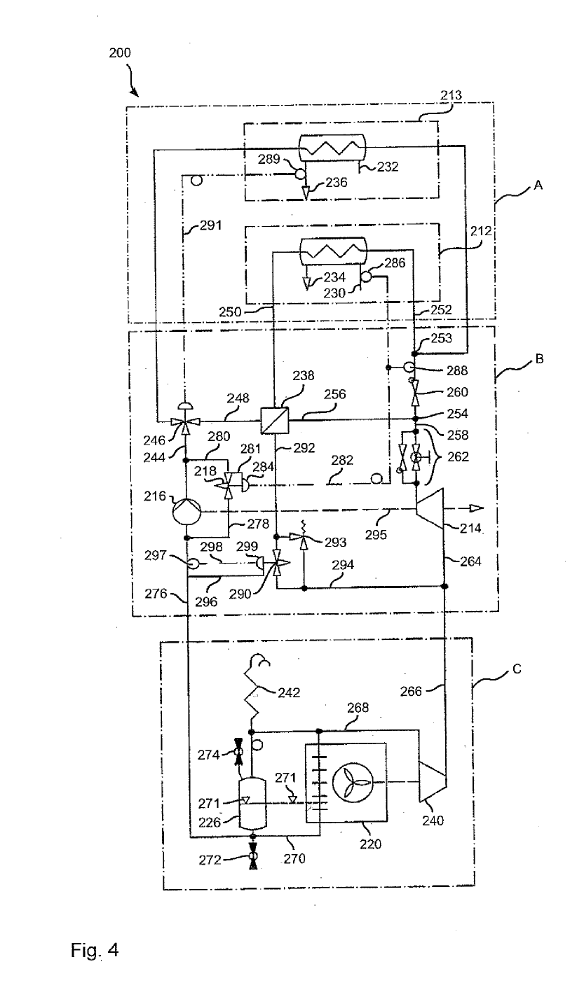

FIG. 4 shows a block diagram of a second embodiment of a heat engine 200 according to the invention. In the block diagram of FIG. 4 which uses standard symbols, lines carrying the working medium are shown as continuous lines. Capillary lines are shown as dot-dash lines and additionally provided with a circle symbol. These can optionally also be executed as electrical lines having corresponding sensors. Membranes or gas volumes closed by membranes are shown as semicircles. Continuously adjustable valves are additionally provided with an arrow-shaped triangle symbol.

The general structure of the heat engine 200 is similar to the structure of the heat engine 10 shown in FIG. 1. This comprises the essential main assemblies evaporator A, expander B with the feed pump interpreted as a separate assembly, and condenser C. The evaporator assembly A comprises a main flow evaporator 212 and an EGR evaporator 213. Both evaporators 212, 213 have the exhaust gas stream from the internal combustion engine, not shown, flowing therethrough and consequently have exhaust gas inlets 230, 232 and exhaust gas outlets 234, 236. The pump-steam engine assembly B comprises the steam engine 214 and the feed pump 216. The feed pump 216 is mechanically coupled to the steam engine 214 and is driven by this. This is shown symbolically by a dashed line 295.

Furthermore, an additional heat exchanger 238 is provided in the assembly B. In addition to the actual condenser 220, the condenser assembly C has an appurtenant turbine 240, a storage container or reservoir 226 and a cooling coil 242.

Starting from the outlet of the feed pump 216, the cooperation of the elements of the various assemblies and the individual connections of the components to one another are now explained. The feed pump 216 conveys the liquid working medium via the line 244 to a distributing valve 246. There the working medium stream is divided and one part is fed to the EGR evaporator 213 and another part is fed to the main flow evaporator 212. The spitting ratio is determined from the exhaust gas outlet temperature required for the EGR evaporator at the EGR evaporator outlet 236. This temperature is supplied to the distributing valve 246 via a capillary 291 with a sensing element 289 or a suitable electrical sensor solution.

The still-liquid working medium passes from the distributing valve 246 to the heat exchanger 238 via a line 248. This acts as a pre-heater if required and heats the working medium. The heat exchanger 238 is preferably configured as a counterflow heat exchanger. The working medium possibly pre-heated by means of the pre-heater 238 is passed via the connecting line 250 to the main flow evaporator 212 which is also designed as a counterflow heat exchanger. There the working medium is heated further by means of the exhaust gases entering at the inlet 230 and leaves the main flow evaporator 212 via a line 252.

Downstream of the line node 253, where the mass flow of the main flow evaporator 212 and that of the EGR evaporator 213 mix, the combined mass flow flows via a check valve 260. The check valve 260 is provided for the case when the steam engine 214 is starting up. This can then operate as a condenser and convey the working medium backwards in the direction opposite to the envisaged direction of flow. The check valve 260 thus prevents any emptying of evaporator and pump.

The working medium flow is divided at the following line node 254. Some passes via the line 256 to the pre-heater to pre-heat the liquid working medium there as described. The other part flows via the line 258 to a shut-off valve 262. The shut-off valve 262 is used for a rapid blocking of the mass flow to the evaporator 214, for example, in the event of braking or coupling.

In contrast to the block diagram in FIG. 1, the evaporator here is not emptied in the event of a required loss of load which is necessary from the energy viewpoint when the evaporator contents are fairly large.

The shut-off valve is additionally equipped with a return function so that when starting up, any liquid fluid can flow in the direction of the pre-heater, even when it is shut off.

From the steam engine or expander 214, the expanded working medium is supplied via lines 264, 266 to the turbine 240 driving the fan at the air-cooled condenser 220 and passes from there via the line 268 into the condenser 220. This principle achieves a good adaptation of the cooling air mass flow to the working medium mass flow in a simple manner. The condensate collecting in the condenser 220 and located at a specific height is undercooled and supplied via a line 270 to the storage container 226. The triangles 271 indicate the liquid level which can be monitored by a sight glass in the storage container 220. The reservoir 226 and the condenser 220 can be emptied via a drain valve 272, the reservoir 226 can be filled via a filling valve 274.

The upper side of the reservoir 226 is connected to a cooling coil 242. This comprises, for example, a long hose which can extend substantially perpendicularly and allows pressure compensation with the surroundings. The upper end is configured such that no rain water can penetrate. The working medium possibly located in the air of the condenser 220 can condense via the cooling coil and flow back into the reservoir 226. A line 276 connects the condenser 220 or the reservoir 226 to the feed pump 216, whereby the circuit is closed.

The embodiment of FIG. 4 comprises two valves which regulate the thermodynamic circuit. A valve 218 is disposed parallel to the feed pump 216. The valve is connected via the lines 278 and 280 to the pump inlet on the condenser side or the pump outlet on the evaporator side. The continuously adjustable flow through the valve 218 is controlled, as already described for the valve 18 in FIG. 1, by means of the ratio of the working medium pressure on the pump outlet side and the temperature of the exhaust gas supplied to the evaporator 212 combined with the working medium temperature on the evaporator outlet side. The working medium pressure on the evaporator side is supplied symbolically in FIG. 4 through the line 281, the exhuast gas or working medium temperature being supplied via the capillary line 282 to a membrane 284. In FIG. 4 the capillary 282 has two sensor elements 286, 288. This is necessary as a result of the additional EGR evaporator. A specific embodiment of the valve 218 is described subsequently in FIG. 5. The control circuit formed from the sensing elements 286, 288, the valve 218 and the pump 216 principally controls or regulates the behaviour of the main flow evaporator 212.

The behaviour of the condenser 220 is principally controlled or regulated via a second valve 290. The valve 290 is disposed between the pre-heater 238 and the condenser assembly C. A line 292 connects the pre-heater 238 to the valve 290, a line 294 extends from the valve 290 as far as the line 264 leading from the steam engine 214 to the turbine 240. In a comparable manner to the valve 218, the working medium pressure on the condenser outlet side, symbolically via a line 296, and the temperature of the working medium on the condenser outlet side act on a membrane 299 via a capillary 298. The capillary 298 is connected via a suitable sensing element 297 to the line 276 on the condenser outlet side.

The mode of action of the valve 290 is as follows. As the temperature of the working medium on the condenser outlet side in the line 276 increases, assuming constant working medium pressure, the undercooling of the working medium located in the line 276 decreases. When this falls below a critical value, the valve 290 opens with a continuous response behaviour corresponding to the ratio of temperature and pressure. As a result of the thus increasing mass flow through the lines 292, 294 which connect the pre-heater 238 to the condenser 220, the liquid working medium supplied to the main flow evaporator 212 via the line 250 undergoes stronger pre-heating. In consequence, the heat input from the exhaust gas stream into the working medium cycle at the main flow evaporator 212 diminishes. This enables the condenser 220 to again achieve the desired undercooling of the working medium due to its likewise lower thermal load. The valve 290 is connected in parallel with a safety valve 293 which prevents an excessively high overpressure in the evaporators or in the pre-heater.

FIG. 5 shows a schematic diagram of an embodiment according to the invention of the valves of the heat engine from FIG. 4. The valve 400 has a gas volume 410 in which a membrane 412 is located. The membrane 412 is coupled to a valve body 414. The valve body 414 is pre-tensioned against the membrane 412 by means of a spring 416. The valve body 414 has a conical shape in its side facing away from the membrane 412 and can be moved along an axis Y with respect to the valve seat 418. The relative position of valve body 414 and valve seat 418 determines the flow rate through the valve 418. The working medium to be controlled in regard to its mass flow can enter into the valve via the connection 420 and emerge via the connection 422 or conversely.

When using the valve 400, for example, as a pump regulating valve 218, a different regulating behaviour is obtained depending on whether the connection 420 is occupied by the pump outlet pressure or the pump inlet pressure. If the connection 420 is connected to the pump outlet pressure, a strong influence of the evaporator pressure on the outlet temperature of the main flow evaporator 212 (FIG. 4) or the inlet temperature of the expander 214 is obtained. In the converse case, i.e. when the connection 420 is occupied by the pump inlet pressure and the connection 422 is occupied by the pump outlet pressure, only the valve seat area acts. This brings about a lower influence of the evaporator pressure on the regulating behaviour. This is useful, for example, when using ethanol as working medium.

In both cases, the outlet temperature at the main flow evaporator 212 or the inlet temperature at the expander 214 therefore increase more or less with the evaporator pressure.

This application of a regulating valve as a pump bypass valve for regulating the conveying capacity as a function of the outlet state of the working medium at the evaporator has proved to be particularly advantageous.

1-18. (canceled)

19. A heat engine having a working medium cycle, said heat engine comprising:
an evaporator configured for evaporating a working medium formed as a liquid;
an expander configured for expanding an evaporated said working medium;
a condenser configured for liquefying an expanded said working medium from said expander;
a working medium pump configured for supplying a liquid said working medium to said evaporator; and
a valve configured for controlling an amount of working medium conveyed from said working medium pump to said evaporator, said valve including a valve seat, a valve body, a sensor connected via one of a gas pressure line and another pressure-conducting connection, and a control member one of on said valve body and additionally to said valve body, said valve body configured for regulating a flow rate of said working medium through said valve according to a position of said valve body relative to said valve seat, said control member configured for influencing said position of said valve body according to a control pressure conveyed via said sensor and dependent on a state variable of one of said working medium and another medium.

20. The heat engine according to claim 19, wherein said control member includes one of a membrane and a piston which is acted upon (a) on a first side by a gas medium guided through one of said gas pressure line and said other pressure-conducting connection, and (b) on a second side facing away from said first side at least indirectly by a pressure of said working medium.

21. The heat engine according to claim 19, wherein said sensor includes a gas volume around which one of a main steam and an exhaust gas flows.

22. The heat engine according to claim 19, wherein said working medium pump includes a suction side and a pressure side, said valve being disposed parallel to said working medium pump between said suction side and said pressure side of said working medium pump.

23. The heat engine according to claim 19, wherein said control member is a first control member for controlling said flow rate through said valve, the heat engine further including a second control member configured for controlling said flow rate through one of said valve and an additional valve.

24. The heat engine according to claim 23, wherein said first control member is configured for controlling said flow rate according to a first state variable ratio of said working medium and said second control member is configured for controlling said flow rate according to a second state variable ratio of said working medium.

25. The heat engine according to claim 23, wherein a gas pressure dependent at least one of on a vapor temperature of said evaporated working medium and on an exhaust gas temperature is applied on a gas side of said first control member, at least one of a spring force and a pressure of a liquid said working medium on a pressure side of said working medium pump being applied on a working medium side of said first control member.

26. The heat engine according to claim 23, wherein a gas pressure dependent on a temperature of a liquid said working medium on a suction side of said working medium pump is applied on a gas side of said second control member, at least one of a spring force and a pressure of said liquid working medium on said suction side of said working medium pump being applied on a working medium side of said second control member.

27. The heat engine according to claim 26, wherein said gas side of said second control member one of includes a closed gas volume and is formed by said closed gas volume.

28. The heat engine according to claim 23, wherein said first control member and said second control member are disposed in said valve.

29. The heat engine according to claim 28, wherein said valve includes an adjusting element, said first control member and said second control member acting on said adjusting element.

30. The heat engine according to claim 23, wherein said first control member is disposed in said valve and said second control member is disposed in said additional valve.

31. The heat engine according to claim 23, wherein the heat engine further includes a heat exchanger, said evaporator including an inlet and an outlet, said heat exchanger being connected to said inlet of said evaporator and to said outlet of said evaporator.

32. The heat engine according to claim 31, wherein said additional valve is disposed on said outlet side of said evaporator after said heat exchanger.

33. The heat engine according to claim 31, wherein said heat exchanger is connected to said condenser via said additional valve.

34. The heat engine according to claim 19, wherein said evaporator is a first evaporator, the heat engine further including a second evaporator, said second evaporator being an exhaust gas recirculation evaporator.

35. The heat engine according to claim 34, wherein the heat engine further includes a distributing valve and a sensor, said distributing valve regulating a mass flow of said working medium to said exhaust gas recirculation evaporator as a function of an exhaust gas outlet temperature by way of said sensor.

36. A drive apparatus, comprising:
an internal combustion engine; and
a heat engine having a working medium cycle, said heat engine including an evaporator, an expander, a condenser, a working medium pump, and a valve, said evaporator configured for evaporating a working medium formed as a liquid, said expander configured for expanding an evaporated said working medium, said condenser configured for liquefying an expanded said working medium from said expander, said working medium pump configured for supplying a liquid said working medium to said evaporator, said valve configured for controlling an amount of working medium conveyed from said working medium pump to said evaporator, said valve including a valve seat, a valve body, a sensor connected via one of a gas pressure line and another
